(19) United States
(12) Patent Application Publication
(10) Pub. No.: US 2015/0134432 A1
(43) Pub. Date: May 14, 2015

(54) METHOD AND SYSTEM FOR COMMUNICATING WITH A MOBILE COMMUNICATION DEVICE AT A HOST LOCATION

(71) Applicant: Robert Lewis, Chicago, IL (US)

(72) Inventor: Robert Lewis, Chicago, IL (US)

(21) Appl. No.: 14/539,432

(22) Filed: Nov. 12, 2014

Related U.S. Application Data
(60) Provisional application No. 61/902,927, filed on Nov. 12, 2013.

(51) Int. Cl. G06Q 30/02

(52) U.S. Cl. CPC G06Q 30/0261; G06Q 30/0267; G06Q 30/0222; G06Q 30/0211
USPC 705/14.13; 705/14.58; 705/14.23

(57) ABSTRACT

An embodiment of the present invention provides, among other things, a method for communicating with a mobile communication device of a consumer. The mobile communication device is located at a host location. An invitation to the consumer to communicate via the mobile communication device is delivered to a display physically present at the host location and viewable by the consumer. In response to the delivering, a request is received from the consumer via the mobile communication device. Communicating then takes place with the mobile communication device.

### PRIORITY CLAIM AND REFERENCE TO RELATED APPLICATION

This application claims the benefit of U.S. Provisional Patent Application Ser. No. 61/902,927, filed Nov. 12, 2013, under 35 U.S.C. 119.

### BACKGROUND OF THE INVENTION

A field of the invention is communications. Example applications of the invention include cloud-based or server-based communications with mobile communication devices at defined locations.

It is known to communicate with consumers by communicating messages. Example messages include advertising messages, notices, and other messages. Macro or mass communications typically are delivered to consumers using a broad-based approach, wherein a single message is delivered via a network to reach any consumer reachable by that network. For example, a sponsor may wish to advertise a particular product by purchasing advertising time with a radio or television network and providing advertisement messages. As another example, a sponsor may place advertisements on web pages, or otherwise communicate with a consumer's computer or mobile communication device.

However, such broad-based approached insufficiently target the specific desired consumers. While information such as demographic information can be used to select particular communication channels (e.g., particular web sites, television shows, networks, etc.) to communicate a message, such demographic information is often insufficient to properly target consumers. Even targeting consumers within a geographical area, even if somewhat narrow (e.g., town, ZIP code) can be insufficient in many cases, due at least in part to diversity of consumers within such areas.

Further, it can be very desirable to obtain feedback or interact with a particular consumer. It is known to provide interactive applications for consumers to select and download and use to interact with messengers. Responses by consumers can provide valuable data, such as marketing data and analytics. However, the present inventor has found that a broad-based approach to providing such interaction falls short.

### SUMMARY OF THE INVENTION

An embodiment of the present invention provides, among other things, a method for communicating with a mobile communication device of a consumer. The mobile communication device is located at a host location. An invitation to the consumer to communicate via the mobile communication device is delivered to a display physically present at the host location and viewable by the consumer. In response to the delivering, a request is received from the consumer via the mobile communication device. Communicating then takes place with the mobile communication device.

### BRIEF DESCRIPTION OF THE DRAWINGS

FIG. 1 shows an example network including a platform for communicating with a mobile device at a host location, according to an embodiment of the invention.

FIG. 2 shows an example server hardware architecture for communicating with a mobile device at a host location, according to an embodiment of the invention.

FIG. 3 shows an example server software architecture for communicating with a mobile device at a host location.

FIG. 4 shows an example method for communicating with a mobile device at a host location, according to an embodiment of the invention.

FIG. 5 shows a display provided at a host location for use in an example method.

FIG. 6 shows components of an example display.

FIG. 7 shows a mobile communication device display for interacting with a server in an example method.

FIG. 8 shows an example method in which a display at a quick service restaurant (QSR) invites consumers to download a coupon for a free drink via their mobile communication devices.

FIG. 9 shows an example method in which a display at a quick service restaurant (QSR) invites consumers to participate in a contest via their mobile communication devices.

FIG. 10 shows an example method for providing demographic information via communication with mobile communication devices.

### DETAILED DESCRIPTION

The present inventor has discovered that consumers are more likely to elect to engage with messengers if the engagement is part of a platform that is integrated with communication with the consumer at a particular host location, such as a quick service restaurant (QSR). Providing this interaction at the host location ties the location to the engagement by self-selecting the participants (consumers), enhances the consumer experience, provides a somewhat “captive audience,” and can further provide valuable data from or relating to the consumer, particular brands, businesses, or other organizations, including but not limited to demographic data. An example platform provides a unique vehicle for business-to-consumer communications and consumer-to-business communications (C2B). Valuable marketing data can also be obtained from the consumer. The consumer can also benefit by engaging a messenger, and by associating an interactive experience with a brand, business, community organization, etc., at a host location. Example consumer benefits include brand to lifestyle relationship, entertainment, the chance to obtain restricted or exclusive information, deals, opportunities, etc.

An embodiment of the invention provides a method for inviting consumer-to-business (C2B) communications via mobile communication devices while the consumer is at a host location. Example host locations include (but are not limited to) quick service restaurants (QSRs). Other example host locations include, but are not limited to, businesses, government buildings, meeting places, non-profit organization locations, parks, educational institutions, retail establishments, etc. Portions of such locations can define host locations as well (e.g., a particular location in a shopping mall, a floor of a building, etc.).

The host location is provided with one or more displays (also referred to herein as monitors, televisions, or digital signs) for displaying content, e.g., media content, to the consumer, one particular example being in-store digital displays. The content includes invitations to the consumer to interact via mobile devices or other computers. Reaching the consumer at a host location further provides a self-selecting, targeted designated market area (DMA) that is currently believed to be unaccounted for by individual demographic information, such as age, gender, race, income or broader geographical location (regions, etc.)

An example system or platform is preferably an internet or cloud-based system, though other computer systems/networks are possible. The system can be connected to advertisers and other businesses and organizations, such as the host brand (e.g., a QSR brand); partner brands, namely brands that partner with the host brand (e.g., soft drink and food brands); franchisees (e.g., a QSR franchisee); and third parties, such as neighborhood businesses (e.g., barbershops, beauty salons, grocery stores, automotive dealers), community groups, local charities, etc. The system can further be connected to one or more media content providers. The system can also be connected to or include one or more displays at the host location. The display(s) can be fed content directly or via a separate or central distribution channel or devices located at the host location. Consumers can interface with the system via the monitors, and via mobile communications devices, such as via mobile internet or other mobile communications protocols, or such as LAN, WLAN, PAN, or WAN routers, or other interne access points disposed at or near the host location.

Preferred embodiments will now be discussed with respect to the drawings. The drawings include schematic figures that are not to scale, which will be fully understood by skilled artisans with reference to the accompanying description. Features may be exaggerated for purposes of illustration. From the preferred embodiments, artisans will recognize additional features and broader aspects of the invention.

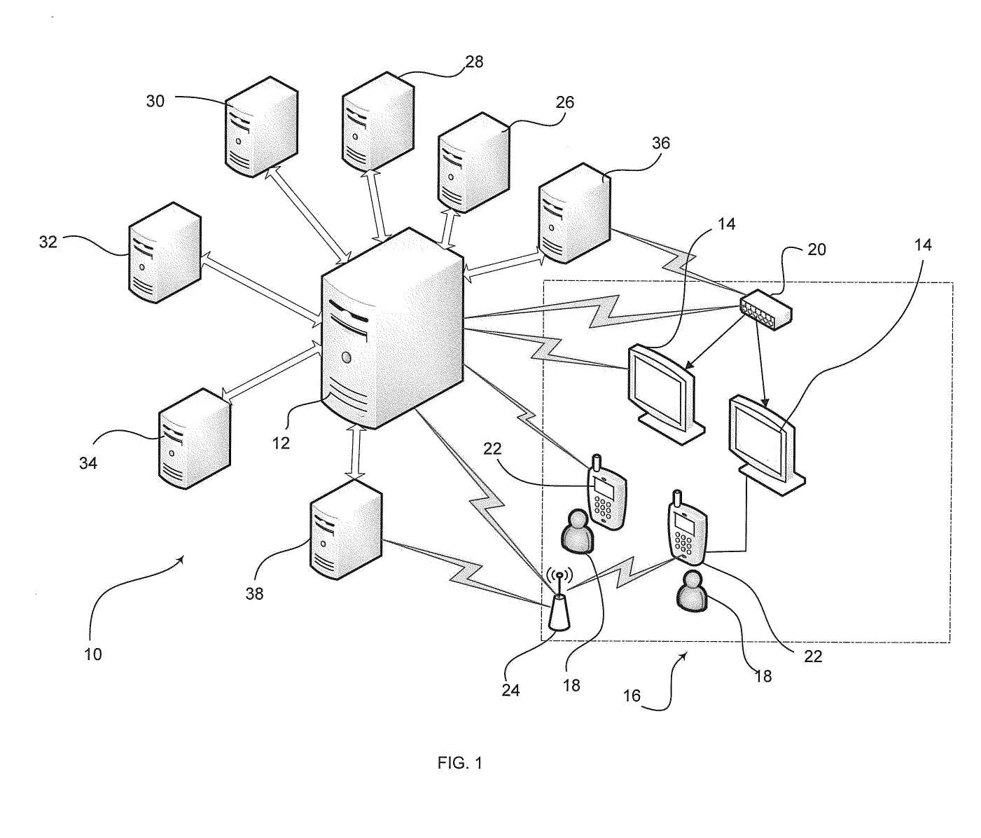

FIG. 1 shows a network including a platform 10 useful in performing example inventive methods. The platform 10 includes a server 12, which can include a plurality of servers, or be a cloud-based system. The server 12 is in communication, either directly or indirectly, with one or more displays 14 at a host location 16. The host location 16 is a specifically bounded, physical premises where the one or more displays 14 can be physically viewed from that premises, as opposed to a more general geographic region, ZIP code, or other general area, and as opposed to the displays being merely linked to or in communication with the premises. For example, the host location 16 can be within a building structure, and the structure itself can define the location. As another example, the host location 16 can be a specific area within a building in which one or more displays 14 are visible. The displays 14 can be physically viewed by consumers 18 present at that location (e.g., inside the structure or within a designated area). According to example methods, this allows the consumers 18 to self-select, e.g., by the consumers deciding to enter the host location 16 and physically viewing the display 14. A non-limiting example host location 16 is a quick service restaurant (QSR), which can be bounded by the area of the QSR itself.

In FIG. 1, an example direct communication is shown between the server 12 and one of the displays 14, and an indirect communication is also shown via a hub 20, which can distribute content to the displays. Further, the server 12 is in communication, either directly or indirectly, with one or more mobile communication devices 22 of consumers 18 (i.e., held by the consumers), which are present at the host location 16. In FIG. 1, an example direct communication is shown between the server 12 and one of the mobile communication devices 22, and an indirect communication to the other mobile communication device via a wireless access point and/or mobile service provider (e.g., a Wi-Fi access point) 24.

The server 12 further is linked (which can be one-way or two-way, directly or indirectly, depending on particular methods) with servers or point of sale (POS) of various organizations. Example servers include servers for a host brand 26, franchisee 28, partner brand 30, community organization 32, and a third party business 34.

A server for a content provider 36 is in communication with the server 12, though in other embodiments, content can be provided on or by the server itself. The content provider 36 can itself be in communication with the displays 14, either directly (not shown) or indirectly, such as via the hub 20, such that the server 12 is in indirect communication with the displays via the content provider. The content provider 36 can also be separately linked to one or more of the other servers 26, 28, 30, 32, 34, though this is not shown in FIG. 1. A telecommunications server 38 or gateway can also be linked to the server 12 and arranged for separately communicating with the mobile communications devices 22, either directly (not shown) or via the wireless access point 24. A non-limiting example telecommunications server 38 is a short message service (SMS) server. In some example methods, the server 12 can communicate with the mobile communication devices 22 indirectly via a network with the telecommunications server 38. Multiple telecommunications servers 38 can be provided. All connections can be one-way or two-way, in any suitable combination, as needed for performance of particular methods.

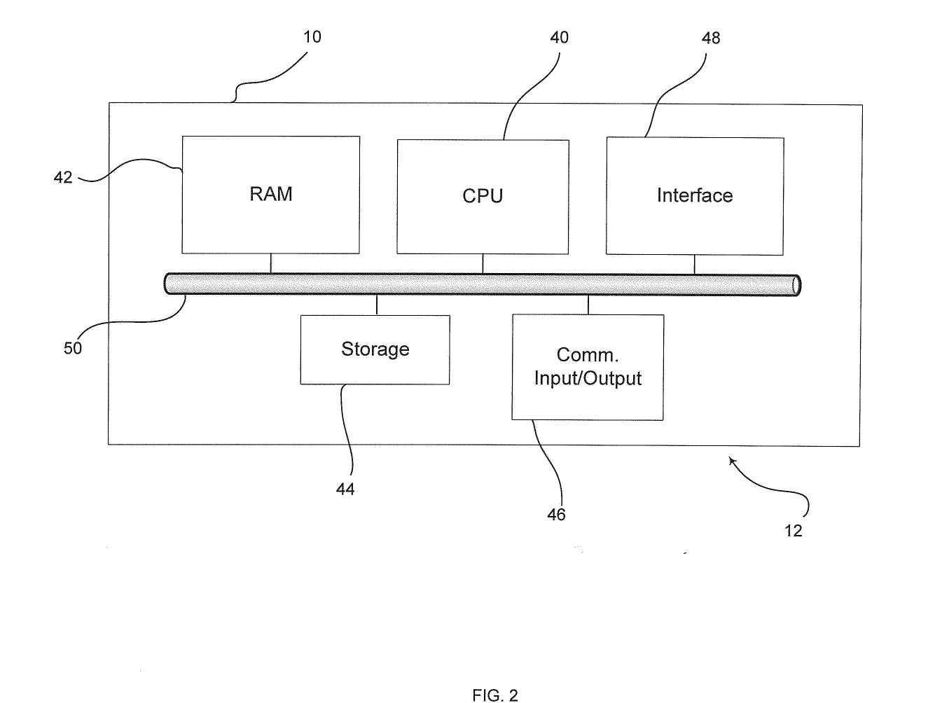

FIG. 2 shows example hardware for the server 12. The server 12 can include conventional server hardware as will be appreciated by those of ordinary skill in the art. A non-limiting example server is a Network Operating Center (NOC), though other servers can be used. The server 12 includes a suitable processor 40, which may be embodied in a central processing unit. Memory 42 (e.g., random access memory (RAM)), storage 44, and communication input/output devices 46 are also provided. An interface 48, e.g., using software such as but not limited to TeamViewer, Netscape, Microsoft, or other software, can be provided for accessing the server 12 for backend programming, maintenance, etc. The memory 42, processor 40, and communication input/output devices 46 can be mounted to a suitable motherboard, as will be appreciated by those of ordinary skill in the art. A bus 50 is provided for communication among the server components. The server can be powered using a power supply, as will be appreciated.

The server 12 can run suitable operating system software, such as but not limited to Linux, UNIX, Ubuntu, Windows Server, etc. Further, the server 12 can include software, hardware, or firmware (or combination) instructions for causing the server to execute methods of the present invention. These instructions can be provided via, for instance, non-transitory media that is read by the server 12 using a suitable media reader (not shown), stored instructions in the storage 44, accessed from external sources, embedded in a specially configured board (e.g., an application specific integrated circuit (ASIC), or provided in other ways.

The displays 14 can be embodied in any suitable monitor or screen for displaying content. The displays 14 preferably are of a sufficient size such that they can be viewed by multiple people at a particular host location 16, though they could be smaller or even portable displays, particularly if multiple displays are provided at various locations. Non-limiting example displays 14 include CRT, LCD, LED, OLED, plasma, front or rear projection, or any other suitable physical display. Tablet computers, computer monitors, electronic billboards, or other digital signs may be used as well. Displays 14 may be provided (e.g., mounted or provided on a stand) and positioned at the host location 16 using methods and devices that will be apparent. The displays 14 may be fed signals for displaying content via wires (e.g., suitable audio/video cables, Ethernet ports, etc.) or wirelessly.

The mobile communication devices 22 can be embodied in any suitable portable device that is capable of being transported by the consumer 18 into the host location 16 and of communicating directly or indirectly with the server 12 to participate in example methods of the invention. Non-limiting mobile communication devices 22 include smart phones, tablets, portable computers, hybrid tablet computers, smart watches or bands, wearable computers, personal digital assistants, and others. Example hubs 20 and wireless access points 24 can include conventional hubs and access points are will be appreciated by those of ordinary skill in the art. Mobile communication devices 22 can run standard or customized operating systems, and can interact with the server 12 or other network components (such as but not limited to the telecommunications server 38) via mobile web access, via mobile applications (apps), via messaging services, via push or pull notifications, or in other ways.

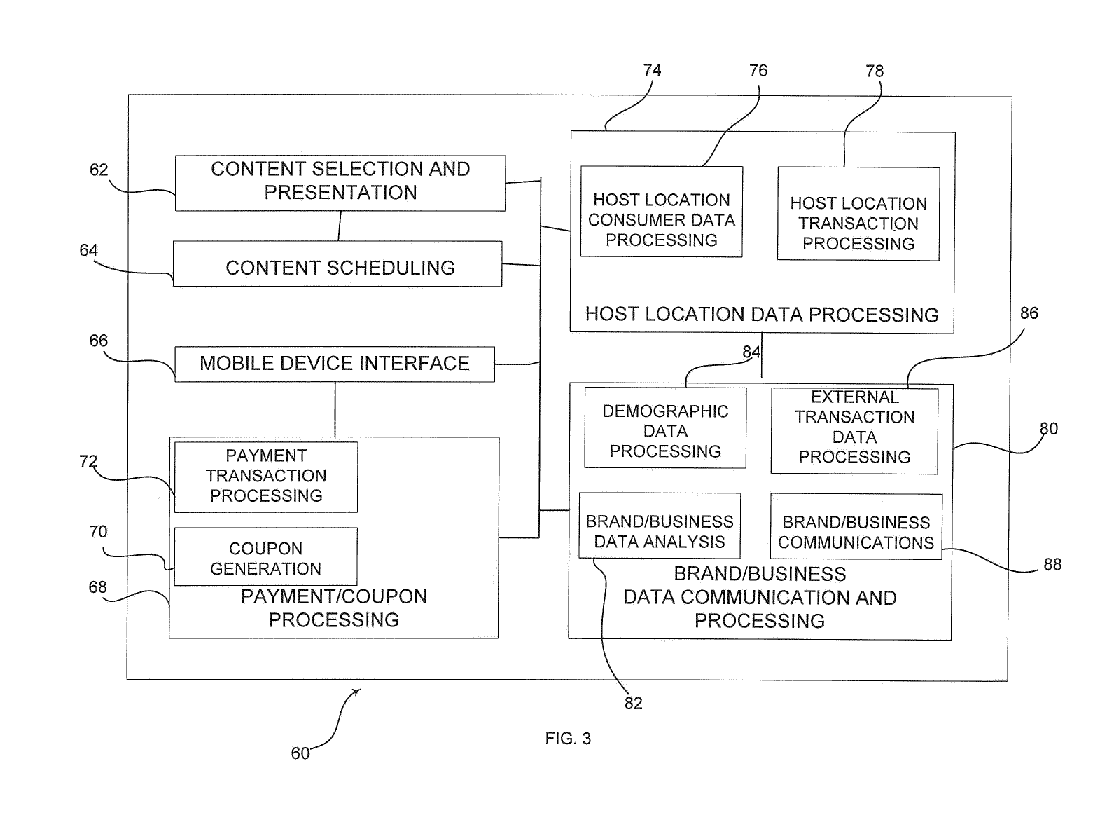

FIG. 3 shows an example software framework 60 for use in example embodiments of the invention. The software framework 60 can be provided entirely or partially within the server 12, or distributed among several networked servers. A content selection and presentation module 62 selects available content from one or more content providers 36, or from content stored or otherwise accessible by the server 12 itself, and transmits the content to the displays 14. This transmission can include, for instance, the server 12 itself feeding the content as a signal to the displays 14, or can include initiating delivery of the content by, for instance, sending a signal to the content providers 36 directing the content providers to send the content to the displays.

A content scheduling module 64 can be provided for allowing the content selection and presentation module 62 to select and transmit content according to a schedule. In some example embodiments, this schedule is determined by communicating with one or more third parties such as the host brand 26, franchisee 28, partner brand 30, community organization 32, third party business 34, etc. For example, content to be displayed for a brand promotion can be scheduled according to a promotion schedule provided by communication with the host brand 26. As another example, a third party business 34 may wish to assess consumer response to particular messages at the host location 16, and a schedule for transmitting content can be provided to do so by testing the messages as invitations. Content scheduling can include content for multiple and varied businesses and organizations. Preferably, by scheduling content, dates and/or times (Dayparts) when particular content is being presented can provide additional data for analyzing effectiveness of the content being presented.

The content that is delivered can include interactive content, non-interactive content, entertainment content, lifestyle content, news content, advertisement or other informational content, or any suitable content that is sufficient to deliver the invitation to the displays. It is preferred, though, that the content be selected and/or produce to maximize engagement by consumers that view the content. Various content can be combined or integrated. More persistent content (Brand Centric Content) (e.g., content indicating a brand for the host location) can be combined with rotating content or content that is presented only a limited number of times. Non-limiting examples of content are shown and described elsewhere herein.

A mobile device interface module 66 is provided for interfacing with the one or more mobile communication devices 22. This interface module 66 preferably can receive, either directly or indirectly, communications from the mobile communication devices 22 such as requests for further interaction, feedback, data, payment information (e.g., if a consumer orders an item), interactive responses, and other communications. Further, the interface module 22 preferably can deliver, either directly or indirectly, communications to the mobile communication devices 22 such as interactive applications, interactive web-based content (games, video, audio, etc.), displayed messages, alerts, coupons (e.g., bar codes, QR codes, passcodes, etc.), mobile commerce or other mobile transaction interfaces, or other content.

Customized mobile applications can be provided either for download upon request (e.g., a unique local app), or otherwise available to consumers' mobile communication devices for facilitating interaction (e.g., an app already downloaded to a mobile communication device as part of, say, a loyalty program that is then brought to the host location 16). Example indirect communications with the mobile communication device 22 can be via a network with one or more access points, or via the telecommunications server 38, which can be embodied in, for instance, a telecommunications provider such as a wireless interne provider, a message server, etc. Those of ordinary skill in the art will appreciate methods for facilitating connections with mobile communication devices.

A payment/coupon processing module 68 is provided for generating or processing coupons (bar codes, etc.) and transaction information for particular interactions with the mobile communication devices 22. A coupon generation module 70 selects or generates (e.g., by coding, hashing, or other methods) coupons, which can be embodied in bar codes, QR codes, passcodes, authorizations for touchless transactions, etc. The coupon generation module 70 can also communicate with third parties if needed to select or retrieve coupons for delivery. A payment transaction processing module 72 provides processing for payments from consumers via the mobile communication devices 22, and in some example embodiments can also provide processing for loyalty programs or other services offered to consumers that may be independent of the particular host location 16. Payment processing and coupon or code generation methods, security methods, etc. will be appreciated by those of ordinary skill in the art.

A host location data processing module 74 configured for receiving and processing host location related data, includes a host location consumer data processing module 76 and a host location transaction processing module 78. The host location consumer data processing module 74 receives and processes data provided by consumers' mobile communication devices 22 (e.g., via the mobile device interface module 66), such as mobile communication device related metadata, survey results, request data, and other types of data. Interactive data such as scores or correctly answered questions during an interactive game or quiz preferably can be tracked by the host location consumer data processing module 76. Further, the host location consumer data processing module 76 can process data related to the particular content that is displayed at the host location at a particular time. For example, the host location consumer data processing module 76 may collect data indicating times when content containing a particular invitation is displayed on the displays, or times when particular content is displayed, and relate this data to the timing of data received from mobile communication devices 22 at the host location (e.g., using database processing or other processing). Location data (e.g., via GPS, Wi-Fi location services, cellular location services, etc.) can also be received and processed to indicate whether the mobile communication device 22 is at the host location, at a separate location that relates to the content, or at a different location.

This host location consumer data can be used, for instance, to assess effectiveness of particular invitations or content, as explained in further detail below. Processing can also be used to determine whether the content that is selected and presented should be adjusted. For example, if the content includes invitations to request a coupon, and the received mobile communication device data indicates that all coupons allocated have been requested, new content can be selected and presented that provides a different invitation.

The host location transaction processing module 78 receives data (e.g., either directly or from a third party server) relating to transactions that take place at the host location 16 or at a designated location relating to the content. For example, if during an interactive session via the mobile communication device 22 consumers are invited to purchase an item at the host location 16 or at a designated location, or to receive a free or discounted item, the data relating to the transaction at the point-of-sale, such as a register, ticket counter, etc., can be received and processed by this module. The additional information provided by the host location transaction processing module 78 provides further insight on effectiveness of the content or invitation, and as with the consumer data processing module 76, this information can be related to the host location 16 (as the consumer must be physically present at the host location and view the display 14 to receive the invitation).

A brand/business data communication and processing module 80 is provided to analyze data provided by the content scheduling module 64, the mobile device interface module 66, the payment/coupon processing module, and the host location data processing module 74. This analysis can be provided to assess the effectiveness of particular content, invitations, host locations, times, etc., and communicate the results (e.g., via reports) to one or more third parties. Additional data provided by third parties via communications can also be supplied as part of the analysis. Processing and analysis can be provided, as a non-limiting example, by suitably configured customer relationship management (CRM) software. Non-limiting example analysis methods are described elsewhere herein.

A brand/business data analysis module 82 analyzes effectiveness of content or invitations, and consumer response relating to particular brands or businesses. For example, for a campaign taking place at a QSR that involves a request for a free drink coupon, consumer response data can be analyzed with respect to the drink brand, the host location business, the franchise, the content provider, and other entities. This data can be integrated with other campaigns either at the same host location or at other host locations for comparison or aggregate analysis.

The demographic data processing module 84 analyzes demographic data that may be provided, e.g., via the host location data processing module 76 or via other methods, such as observation data that is fed to the server 12. Alternatively or additionally, the demographic data processing module 84 can compare demographic data to data received from other sources and relate this data to that provided by, for instance, the host location data processing module 76. Because the consumers self-select by choosing to enter the host location 16, view the delivered content, and interact (or not) with their mobile communication devices 22, a set of demographic data can be provided that is unique from that provided by more general demographic or even geographic categories. Brands or businesses can assess the effectiveness of content or campaigns for a specifically targeted demographic (e.g., the particular consumers entering the host location 16), and/or can better determine demographic data for a host location, brand, business, etc.

The external transaction data processing module 86 receives and assesses brand/business data obtained from locations other than the host location 16 that can be related in some way to the content provided via the displays 14 at the host location. For example, a promotion may include an invitation to purchase discounted movie tickets. The invitation is displayed on the displays 14 at a retail clothing store (a host location). In response to a consumer request for the tickets via the mobile communication device, the server delivers a QR code providing a movie ticket to the mobile communication device. This QR code is redeemed at a location (a movie theater) that is external to the retail clothing store. When the QR code is redeemed, information is returned to the server 12, which can be analyzed to assess the effectiveness of the promotion at the host location.

A brand/business communications module 88 is provided for interfacing with particular brands, businesses, organizations, etc. such as via the servers 26, 28, 30, 32, 34, 36, and for creating requested reports, summaries, tables, spreadsheets, data feeds, or other result data, and communicating the data to such brands, businesses, or organizations. Further, the brand/business communications module 88 may receive information from such brands, businesses, or organizations for configuring, adding, or deleting content scheduling, content, invitations, mobile device communication interfaces (e.g., mobile apps or displays), coupons, etc. This information can be provided to the content selection and presentation module 62, content scheduling module 64, mobile device interface 66, and/or payment/coupon processing modules 72. Also, the brand/business communications module 88 can receive data or instructions useful for performing analysis by the demographic data processing module 84, the brand/business data analysis module 82, and/or the external transaction data processing module 86.

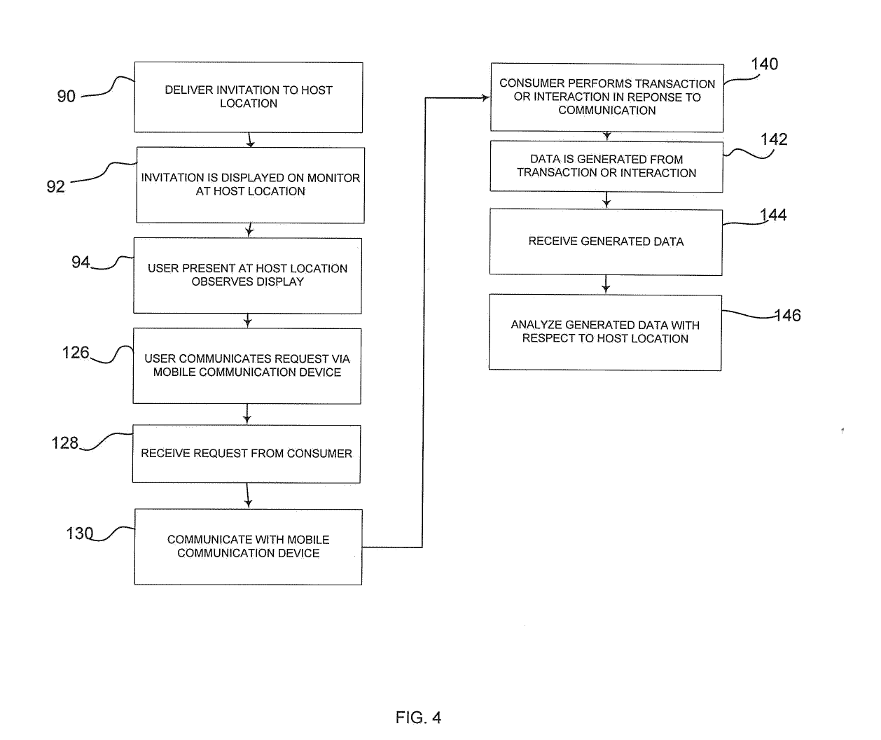

FIG. 4 shows an example method for communicating with the mobile communication devices at the host location. The server 12, e.g., via the content selection and presentation module 62, delivers an invitation (step 90) to consumers present at the host location to engage and communicate with a business or organization, such as but not limited to those described elsewhere herein. The invitation can be, for instance, video, audio, or text that visually and/or aurally invites the consumer to engage via his/her mobile communication device, e.g., invitations to communicate with the server, with host brands, partner brands, franchisees, third parties, etc.

The invitation can be provided by the server 12 directly to the display(s) 14 via a network, or provided (e.g., via a network or directly sent) to one or more third parties, such as the content provider 36, that in turn transmit(s) the notice to the displays. Transmitting such invitations can be provided using methods known to those of ordinary skill in the art. However, as opposed to conventional methods that disseminate video content on a broad basis for businesses, such as television channels, or even video content for a smaller locale, such as a particular state, city, ZIP code, etc., an embodiment method can provide narrowcasting down to a particular host location.

The invitation can be selected and/or customized if desired based on the consumers that visit the host location 16, selected based on particular demographic data, selected as part of a broader campaign, or selected or customized in any other way. The invitation can also be included in content provided to the displays 14 by a separate media content provider such as a location advertiser, which is transmitted after being requested by the server 12. Content that is presented at the host location 16 can be, but need not be, tailored or selected for the host location or even unique to the host location.

The invitation can be on behalf of product or service sponsors, vendors, franchisees, business owners, community groups, governmental groups, and other organizations or people, and can be marked or otherwise identified as such, if desired. Products or services may be advertised that are sold at the host location, or that are related to products or services or that are sold there. Other products or services, or other messages, may be advertised as well.

This invitation is provided as media content, or as a part of media content. This media content is displayed on the monitors (the display or displays) at the host location (step 92), so that the media content is viewable by (i.e., within sight of) consumers physically present at the host location (step 94). The media content preferably provides advertising or other media content to the host location, and most preferably is in the form of video which is displayed on the displays at the host location. The invitations and/or media content can be selected and delivered according to a schedule as provided by the content scheduling module or otherwise. Particular example media content includes a video for which a consumer can obtain additional content by employing an application (app) such as an interactive application, a game, a media player, a mention of a coupon or other offer that can be obtained or accepted via the app, notice that the app can provide a second-screen for further interaction, and others. Particular examples of content include news feed, social media feeds, messages or alerts, weather updates, entertainment content, tailored advertising content, poll/survey questions, quizzes, visual art works, etc. Preferably, the media content displayed is of high visual quality (e.g., high resolution, vivid colors) for improved engagement with consumers. More preferably, but not necessarily, some of the media content promotes interactivity with consumers via mobile communication devices. As with the invitations, the content can be marked or otherwise visually associated with a particular organization.

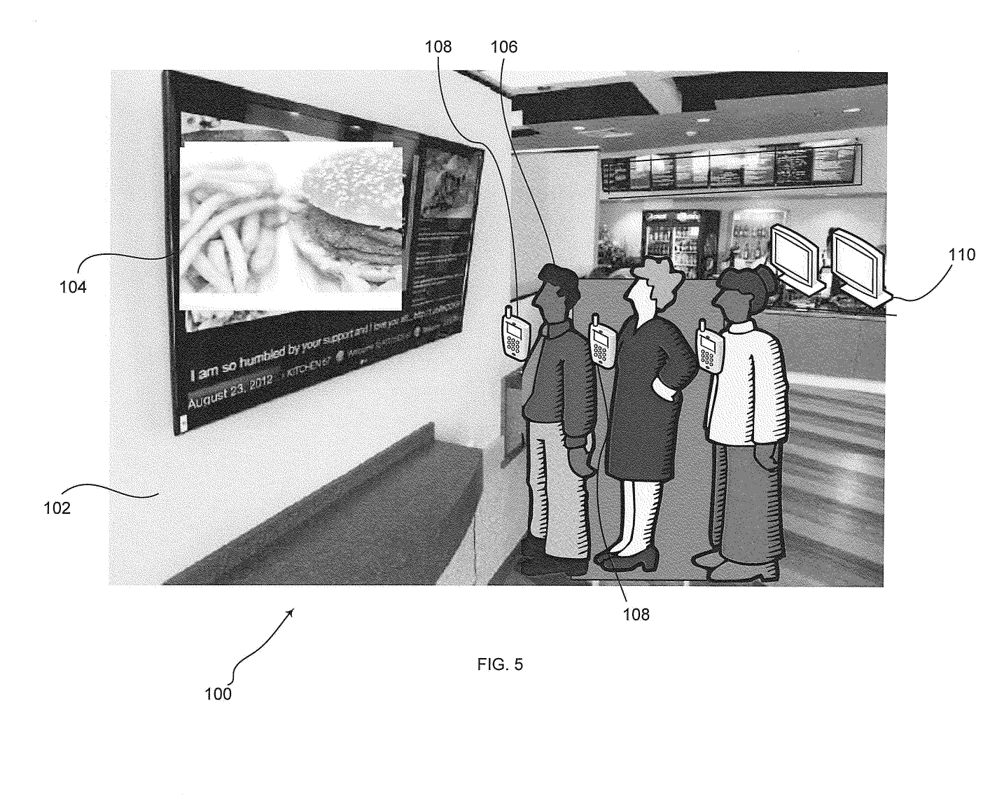

FIG. 5 shows an example host location 100 embodied in a QSR. The QSR 100 includes a wall 102 in which a display 104 is mounted thereon, displaying delivered content. The display 104 can be in communication with the server 12 either directly or indirectly (e.g., networked to the server). Consumers (users) 106 having mobile communication devices 108 are present at the host location and physically located so that the display 104 and content are directly viewable. The QSR 100 further includes registers 110 for point-of-sale transactions, as will be appreciated by those of ordinary skill in the art.

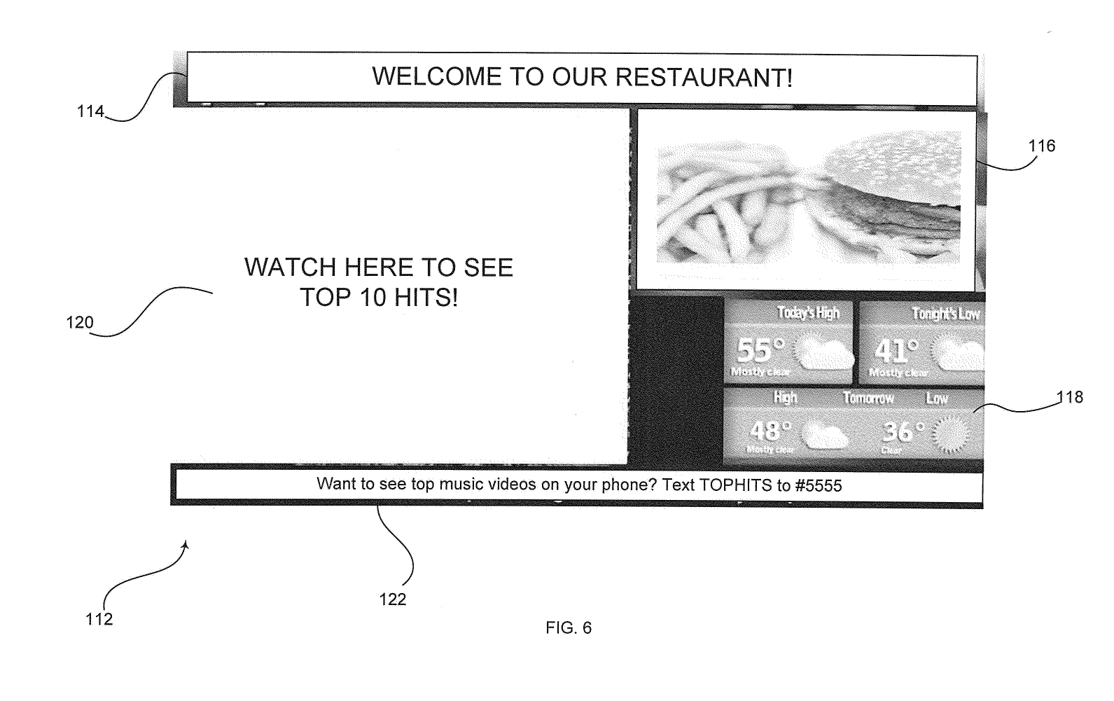

FIG. 6 shows an example display screen 112 showing video content. A first portion, e.g., a banner 114, indicates the QSR name. A second portion 116 of the display shows a menu item. A third portion 118 of the display indicates local weather. A fourth, larger portion 120 of the display conveys entertainment content embodied in a “Top 10 Hits” music video. Finally, a fifth, scrolling portion 122 of the display invites the consumer to send a text to receive music videos on his/her phone. The fifth portion 122 of the display, alone or in combination with the fourth portion 120, provides an example invitation (in this example, the entertainment content is related to the invitation to receive additional content). This invitation is viewable by the consumers 108 physically present at the QSR 100.

Returning to FIG. 4, the user present at the host location observes the display and thus views the invitation (step 94). The user then sends a request (step 126) for additional interaction via the mobile communication device 14. This request can take many forms, e.g., text, video, or audio messages, clicking on links (e.g., an HTTP request), a phone call, uploading data, and other forms. The consumer may request, for example, a download of an interactive application, a coupon, a message, an interactive session (e.g., a game, a survey, etc.), a link to an interactive session, particular information (e.g., an answer to a trivia question), and/or audio, video, or text content.

The server 12, e.g., via the mobile device interface 66, receives the request from the consumer's mobile communication device (step 128). This request can be received directly or indirectly using methods known by those of ordinary skill in the art. As non-limiting examples, the request may be received via the display itself (e.g., if the display is networked and configured to interact wirelessly with the mobile communication devices), via the wireless access point, via the wireless communication server, or in other ways.

Communication with the consumer via his/her mobile communication device then takes place (step 130). The interaction may or may not be substantially in real time. In examples of non-real time uses, the consumer may interact with the application, and information may be later transmitted to the server 12. As another example, the server 12 may transmit information via the interactive application, via a web or interne communication, via a message, or otherwise, and later accessed by the consumer at the host location, or any combination. Substantial real time interaction includes the consumer at the host location sending and/or receiving data with the system in substantially real time.

The communication with the consumer via the mobile communication device 22 may be web-based, including mobile-web-based, may be a standalone application with online features, or otherwise may be provided. An application or other content is optionally delivered to the mobile communication device, for instance if the application or content is not already on the consumer's mobile communication device.

Communication with the consumer via the mobile communication device includes, but is not limited to, interacting via an existing app, via a downloadable app, via browser, via messages, via social media, etc. Interaction can include, but is not limited to, downloading content such as video or audio content, interactive games, contests, voice opinions or other survey responses, downloading coupons, or others. Proprietary content provided to mobile communications can be provided with digital rights management, such as but not limited to digital watermarks, if desired.

Preferably, but not necessarily, the communication with the mobile communication device is related to the invitation (and the request). For example, if the invitation is to request a coupon or a ticket, the request can be for the coupon, and the communication can include receiving a bar code, passcode, QR code, e-ticket, or other coupon or ticket equivalent for redemption. If the invitation is to request video content, the request can be a text to a designated number, and the communication can include a download of the video content. If the invitation is to participate in a game, survey, contest, or other interactive experience, the request may be a request to download a game, an answer to a question, a turn in an interactive game, or other related request. The mobile communication device can then receive, for example, an indicator of whether an answer is or is not correct, a confirmation message, a downloaded prize, an opponent's turn in an interactive game, etc. Prizes, games, entertainment, advertising, content, messages, and other content provided to the mobile communication device can be, but need not be, related to the business of the particular host location, or may be related to other organizations (sponsors, brands, community groups, government organizations, etc.). In some embodiments, the consumer may also, via the mobile communication device 22, interact directly with the content displayed on the display 14 (e.g., by scanning codes or other items on the display, communicating with the display via wireless communications protocols, etc.), and send requests and receive communications accordingly, though this is not required in all embodiments.

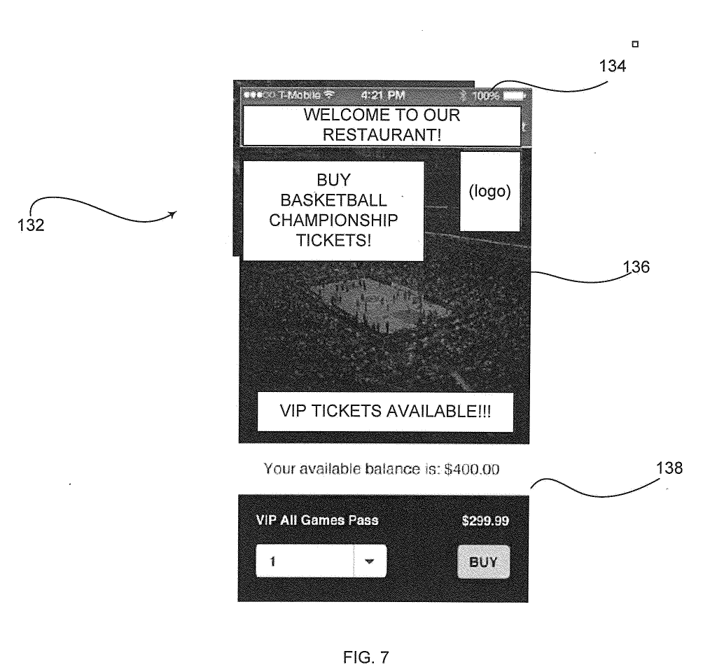

FIG. 7 shows an example display 132 on a touchscreen mobile communication device providing an interface during a communication with the server. The mobile display 132 includes a banner 134 indicating a franchise brand, an advertisement 136 for a sporting event, and a mobile order form 138 for allowing the consumer to purchase a ticket directly from the interface. In an example embodiment, the display 132 can include an invitation to request access to an ecommerce site for purchasing an item only available via that request (e.g., a unique URL). In this way, the purchase can be limited to those that view the invitation (and thus are present at the host location).

Returning to FIG. 4, in some example methods, the consumer performs a transaction or interaction (step 140) in response to the communication. For example, the consumer may participate in an interactive game or survey using the mobile communication device 22. As another example, the communication to the mobile communication device 22 can involve a potential transaction that the consumer can elect to perform. For example, if the communication includes a coupon, the coupon can then be redeemed, either at the host location point-of-sale for a purchase (or free item), or at a different location (e.g., an e-ticket at a theater or sporting event). The communication can also include a mobile interface for performing a transaction directly from the mobile communication device, such as the interface shown in FIG. 7. It is also contemplated that transactions can be performed without the mobile communication device after the communication, though it is preferred that the mobile communication device be employed in the transaction.

As a result of the request received from the mobile communication device, the communication from the mobile communication device, or further interactions taking place via the mobile communication device, the server 12 can obtain feedback information, e.g., marketing data, which is generated from the transactions or interactions (step 142). This data is then received (step 144), for instance, by the server 12 via the mobile device interface or from other sources. Alternatively or additionally, the server 12 can receive data generated from the transactions, e.g., via the host location consumer data processing module, the host location point-of transaction processing module, the external transaction data processing module, the brand/business communications module, or otherwise.

The server 12 can then analyze the received data (step 146) with respect to the host location, e.g., using the brand/business data communication and processing module 80. For instance, the generated data can provide a relationship between the presence of the consumer at that host location and the data received via the mobile communication device 22, at a point-of-sale, or by another transaction. Valuable demographic data can be provided. As one example, it has been found that some customers engage businesses in certain locations more than may be typical. Such “over indexing” customers are distinctly representative of a local community, and can be directly engaged with using example methods according to the present invention.

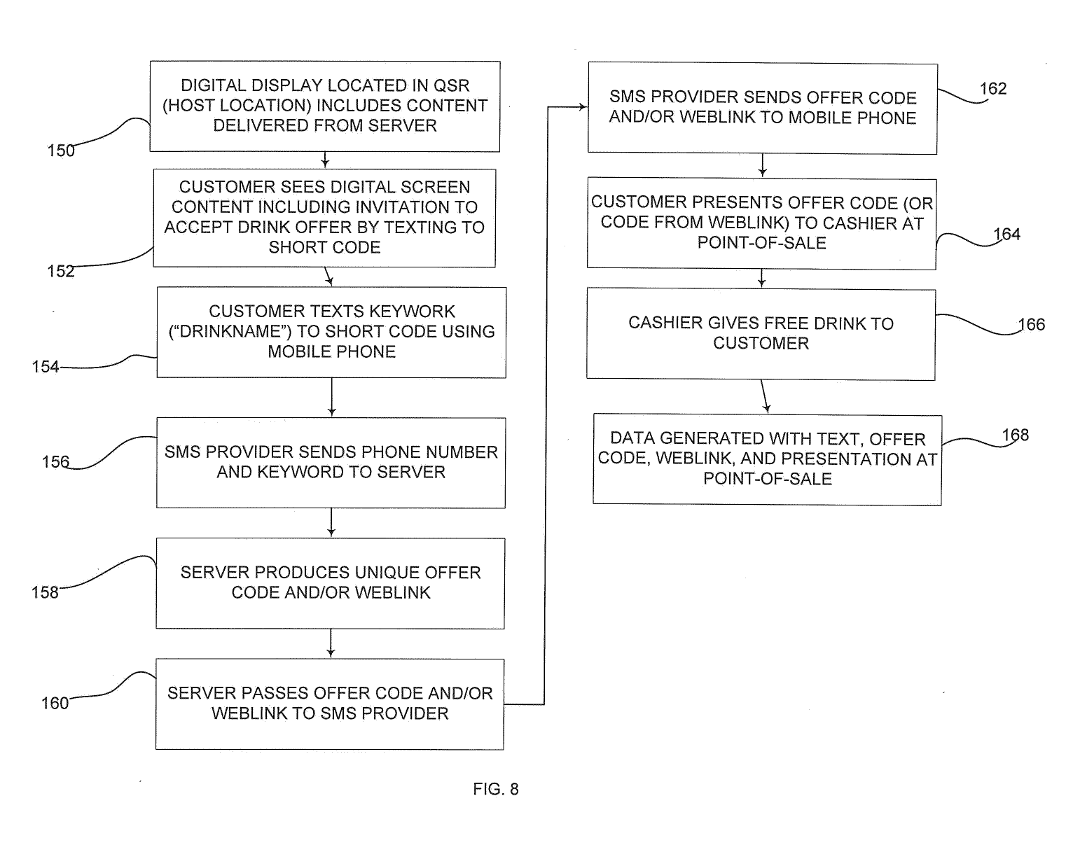

FIG. 8 shows a particular example method of the invention for the QSR shown in FIG. 5. The server 12 delivers, directly or indirectly, video content to the display (step 150). The video content includes an invitation to request a free drink coupon by texting a keyword to a short code. The consumer sees the content on the display (step 152), and uses the mobile communication device to text the keyword (e.g., “DRINKNAME”) to the SMS server (e.g., telecommunications server 38) (step 154), thus requesting additional interaction with the server 12. The SMS server sends (step 156) the mobile communication device's phone number and the keyword to the server 12 so that the server receives the request, e.g., via the mobile device interface or the brand/business communications module.

Next, the server 12, e.g., using the coupon generation module 70, produces a unique offer code and/or a web link (step 158), and sends this offer code or web link back to the SMS server (step 160), which in turn sends the offer code or web link to the mobile communication device (step 162). The web link may link to directions for how to redeem the coupon, or may provide a location to download the code. The consumer then presents the offer code (or clicks on the web link to obtain an offer code or equivalent) (step 164) to the register for a point-of-sale transaction. The consumer receives the free drink (step 166). In an alternative embodiment, the consumer can redeem the coupon at a location separate from the host location, and this external point of transaction can communicate to the server to indicate where/when the coupon is redeemed.

Data is generated (step 168) when the consumer makes a request, e.g., by texting the keyword to the short code, and is also generated when the offer code and/or web link is communicated to the mobile communication device (e.g., by tracking receipt of the offer code, by receiving a request via the web link), and when the offer code is redeemed through the register. Such data can include, for instance, the number of mobile communication devices that sent a request when invited by the display, the number of devices that downloaded the offer code (or clicked a web link), the number of devices that were used to redeem the offer, the times when each step took place, etc. This data can be compared to additional data such as, for instance, the total number of customers that visited the store, the number of mobile communication devices that are detected (e.g., through a local wireless network), etc. The accumulated data can be compared to determine effectiveness (e.g., as a percentage, ratio, trend, timeline, etc.) of a particular consumer experience. Additional demographic data for the host location can be provided during performance of example methods and/or by other methods, and can be integrated with the other data to produce a demographically targeted analysis.

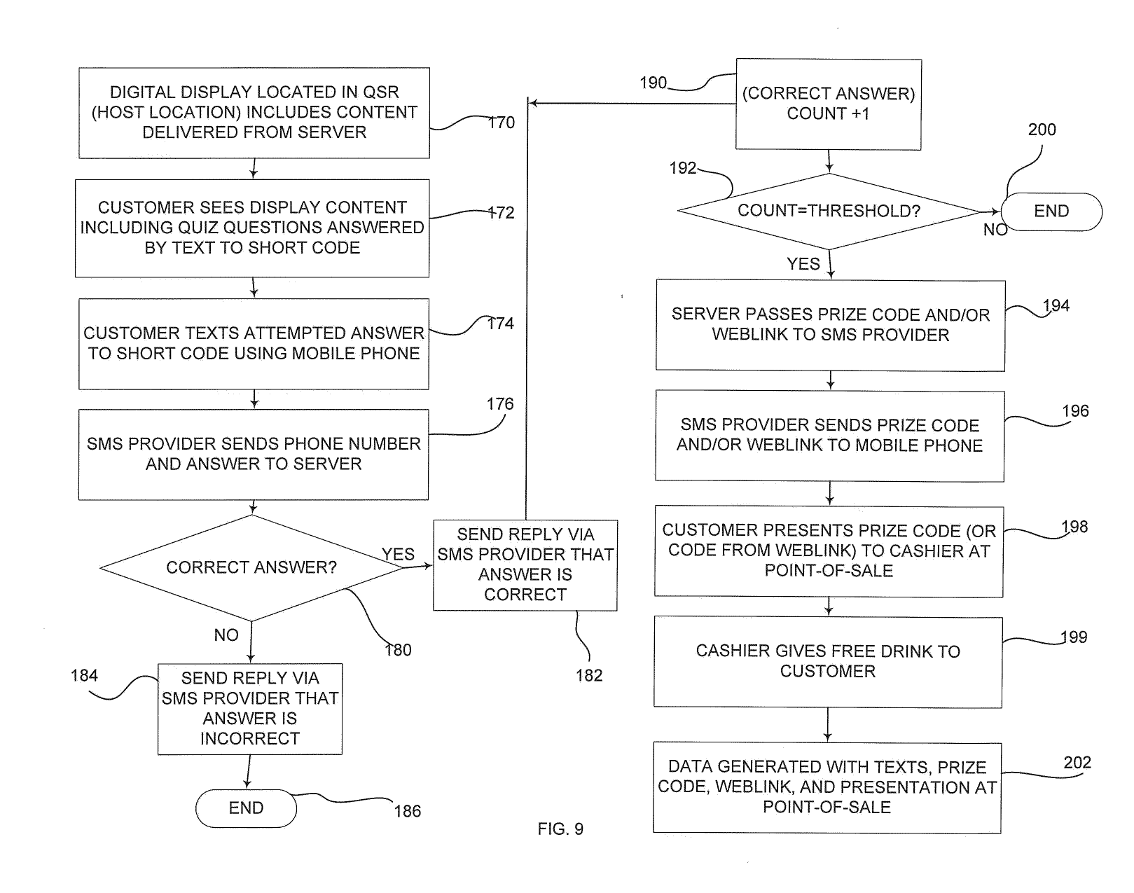

FIG. 9 shows another particular example method of the invention for the QSR shown in FIG. 5, in which an interactive game is provided. Here, the delivered media content to the display at the host location displays questions (step 170), such as survey or quiz questions, and invites the customer to text answers to the questions to win a prize. The consumer views the media content (step 172), and uses his/her mobile communication device to text an answer to a question (step 174), and in turn requests additional interaction from the server. The texts are received by the SMS server, which sends the mobile communication device's phone number and quiz answer to the server 12 (step 176). The server 12, e.g., using the mobile communication interface and the payment/coupon processing modules, tracks correct answers sent from the phone number. The server determines whether the answer is correct (step 180), and preferably, but not necessarily, provides an indication of whether an answer is correct (step 182) or incorrect (step 184) (e.g., a “Correct!” message or a “Try Again” message), and sends this indication to the mobile communication device using the SMS server.

As another alternative, the questions could be presented via a mobile application that is downloaded from the server 12 upon a request from the mobile communication device, and the answers can be sent from the mobile communication device as mobile web communications or other mobile communications. Games can be produced and delivered to the consumer's mobile communication device, and if desired can include a brand or co-brands for sponsorship or other association. Note that the questions could instead be presented via mobile web, and the answers could be sent to the server similarly. Interactive games can be integrated with the mobile communication device for consumers at that location. In some example methods, the consumer can compete with others in a particular host location or at other host locations with other like-minded consumers. This provides a unique engagement opportunity with targeted consumers, allowing sponsors to communicate values, features, and benefits of a brand through the game while incentivizing the consumer. It is contemplated that existing games or interactive applications or messages could be integrated with example methods by, for example, communicating such games, interactive applications, or messages upon a user's request in response to viewing a display at a host location.

Returning to FIG. 9, if the answer is incorrect (step 184), the interaction can end (step 186). If, on the other hand, the answer is correct (step 182), a count of the number of correct answers from the mobile communication device (or from, say, a team, or group of participants, etc.) is increased (step 190). If the number of correct answers reaches a threshold (step 192), e.g., as determined by the server 12, the server generates a coupon and sends a unique prize code and/or web link to the SMS (step 194), which then sends the prize code and/or web link to the mobile communication device (step 196) as discussed above with respect to FIG. 8. The consumer then receives the prize code and/or web link, and uses the prize code and/or web link to receive a prize (step 198), either at the register or at a different point-of-transaction. The prize (e.g., a free drink) is presented to the customer (step 199) If the threshold number of correct answers has not been reached, no prize code is generated at that time (step 200).

As with the example method shown in FIG. 8, data is generated (step 202) when a request is made (step 174), when interaction(s) take place with the mobile communication device (e.g., steps 176, 180, 182, 184, 190), when a web link is clicked (e.g., step 198), and/or when the prize code is eventually redeemed. The number of mobile communication devices that sent the request, redeemed the prize code, or participated in the quiz can be determined. This data can be combined with additional data and analyzed as described above.

In some example methods, a loyalty program may be provided that incorporates the interactive application and other portions of an example system, as will be appreciated by those of ordinary skill in the art. For example, the server, alone or on behalf of the host location, brand, business, or other organization, can interact with consumers using the mobile communication device. This interaction can include games or other communication that requires consumer participation. This participation provides qualification and quantification of real time measurement. Further, participation further engages the consumer. By identifying delivered content or interaction with a business or brand, an association with the consumer can develop. In some example embodiments, previous interactions with consumers can be stored and retrieved for providing accumulated rewards or additional unique benefits for particular consumers.

Franchisee organizations, partners, and other third party organizations can customize and initiate campaigns using example methods, and effectiveness of such campaigns can be assessed. Further, awareness of brands, organizations, etc. can be raised by associating interactive experiences with such brands or organizations. As non-limiting examples, national campaigns and community initiatives can be activated at the host location. A media platform can be presented at the host location to improve relationships and incentives. Partner brands can employ example methods to distribute communications to specific demographic groups and/or geographic areas with a greater specificity than for some conventional methods. The host location itself can benefit from associating with campaigns according to example methods.

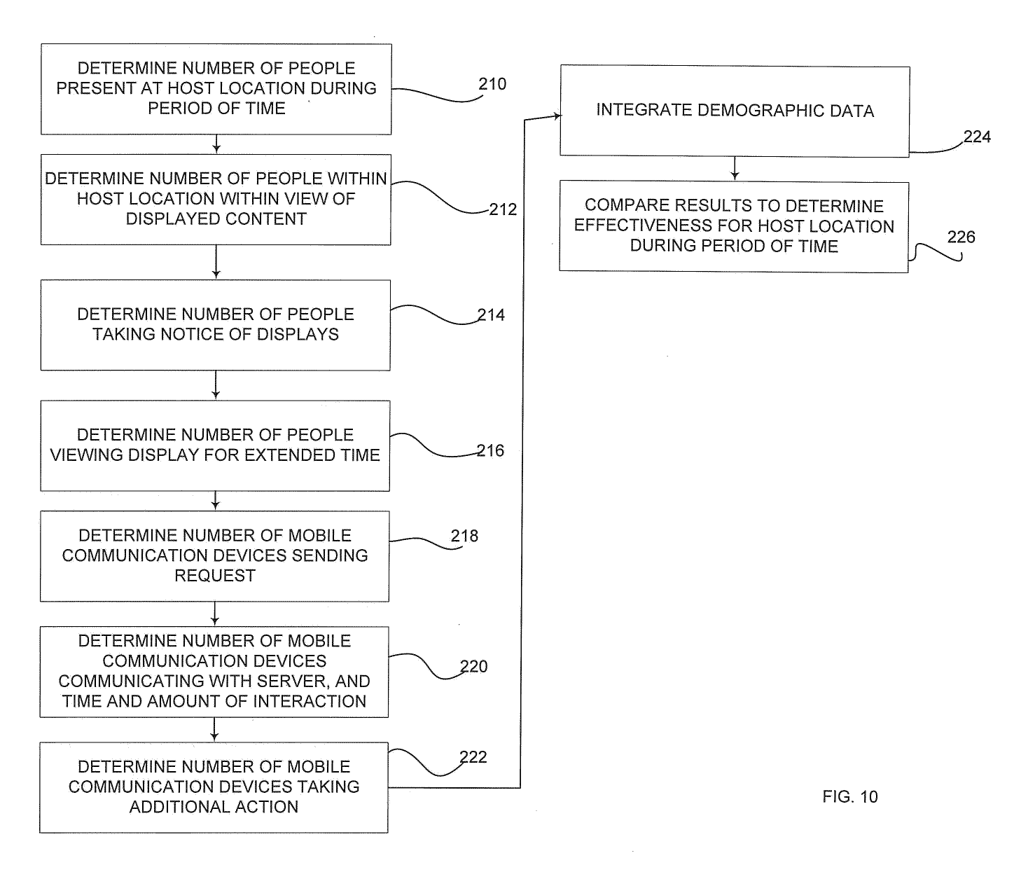

FIG. 10 shows an example method for analyzing data. The self-selection provided by displaying the invitations at the host location allows demographic targeting. The audience of consumers is generally quantified and qualified based on the host location. In other words, the pre-qualifier for a marketing campaign using example methods could simply be defined as the core demographic of the particular host location at a particular time. Thus, the incoming data can be analyzed, e.g., filtered, with respect to the demographics of the host location. This provides insight not otherwise available by advertising in a more broadly-defined location.

In the example method shown in FIG. 10, a number of people (e.g., consumers) present at a particular host location during a particular period of time is determined (step 210), either via observation, or through conventional counting methods. A number of people within the host location that can physically view the displays is similarly determined (step 212). Further, a number of people that are observed to take notice of the displays can be determined (quantified) (step 214), as well as a number of people that view the display for an extended time (“dwell”) (step 216). The number of connected mobile communication devices can also be determined in some example embodiments, e.g., by tracking devices accessing a wireless network at the host location, or in wireless communication with the displays themselves.

Next, the number of mobile communication devices that take action by sending a request during the period of time is determined (quantified) (step 218), as described above. The number of mobile communication devices that communicate with the server (directly or indirectly) is also determined (step 220), and preferably the amount and/or time of communication (and interaction, for interactive communication) is determined as well to assess engagement. Additionally, additional actions taken by the mobile communication device to demonstrate consumer engagement or effectiveness, such as coupon or code redemption, sales, transactions (either at the host location or otherwise), downloaded applications or other content, social media communications can be quantified (step 222).

Additionally, by factoring in desired demographic information for one or more of these events (step 224), effectiveness with respect to particular demographics can be assessed as well. Again, as the demographics are established by self-selection at the host location, example methods of the invention provide an opportunity for marketing that is not available via conventional methods of targeting by region or conventional demographic categories.

One or more of these determined numbers can be compared or related to one another to assess effectiveness of content, brand awareness, and/or overall engagement (step 226), with respect to the host location for a particular period of time. As one non-limiting example, for a hypothetical average restaurant guest traffic of 400 people, 80%, or 320, may be able to physically view the displays. 50% of these people (160) may take notice of the content, and 80% of this group (128) may take notice and remain engaged for a certain time. Of this group, half (64) may request further interaction, 75% (48) of those requesting interaction may communicate with the server, and 75% (36) of those communicating may perform some additional action (e.g., redeem a downloaded code).

Many of these events can further quantified or qualified by factors such as, but not limited to, time, brand or business associated with particular content, invitations, or communications, the subject of a later transaction (e.g., whether a particular prize or deal was accepted), etc., using data that can be provided to the server. Effectiveness can be determined for, for instance, awareness of the host location brand, a brand displayed on the display or on the mobile communication device, etc. Integrating demographic data for the host location at the particular time provides a way to compare results with particular demographic groups for more targeted analysis.

Example methods of the present invention provide, among other benefits, a multi-channel marketing platform that can integrate displays at specific host locations with interactive mobile and on-screen features. The consumer's mobile communication device can be utilized to download host brand or customized loyalty, rewards, offers, payment services, and/or ecommerce applications for use in various retail environments. The consumer is provided content (e.g., entertainment content or informative content), opportunities for new content, discounts, or even prizes, and/or obtains a more direct (e.g., one to one) way to engage with a business or other organization.

Owners of the host location business (e.g., QSR franchisee) can receive more satisfied customers and possible additional revenue from sponsored content. Host brands, partner brands, neighborhood businesses, community groups, and others can benefit from presenting their message via example systems, interacting with a targeted group of consumers, building a relationship with the consumers, and/or receiving feedback and demographic data. A vertical and horizontal ecosystem can be provided among consumers, host locations, brands, businesses, and other organizations.

While various embodiments of the present invention have been shown and described, it should be understood that other modifications, substitutions, and alternatives are apparent to one of ordinary skill in the art. Such modifications, substitutions, and alternatives can be made without departing from the spirit and scope of the invention, which should be determined from the appended claims.

Various features of the invention are set forth in the appended claims.

What is claimed is:

1. A method for communicating with a mobile communication device of a consumer, the mobile communication device being located at a host location, the method comprising:
delivering, to a display physically present at the host location that is viewable by the consumer, an invitation to the consumer to communicate via the mobile communication device;
in response to said delivering, receiving a request from the consumer via the mobile communication device; and
communicating with the mobile communication device.

2. The method of claim 1, wherein said delivering comprising causing the display to present video content that includes the invitation;
wherein the content comprises one or more of entertainment content, news content, weather content, informative content, social media content, questions, or interactive content.

3. The method of claim 2, further comprising:
selecting the content to be presented according to a schedule.

4. The method of claim 2, wherein the content includes multiple content items that are integrated with one another.

5. The method of claim 2, further comprising:
displaying the content on the display at the host location.

6. The method of claim 1, wherein said receiving a request comprises receiving a communication from the mobile communication device requesting content to be downloaded to the mobile communication device.

7. The method of claim 1, wherein said receiving a request comprises receiving a message from the mobile communication device in response to the invitation.

8. The method of claim 1, wherein the received request comprises an answer to a question presented on the display.

9. The method of claim 1, wherein said communicating comprises providing one or more of a coupon, passcode, bar code, quick response (QR) code, or a web link to the mobile communication device.

10. The method of claim 1, wherein said communicating comprises providing one or more of a mobile application, interactive content, or non-interactive content to the mobile communication device.

11. The method of claim 1, wherein said communicating with the mobile communication device takes place via a mobile application previously stored on the mobile communication device.

12. The method of claim 1, further comprising:
receiving data generated as a result of said received request, said communicating, or a subsequent transaction via the mobile communication device; and
analyzing the generated data with respect to the host location.

13. The method of claim 12, wherein the subsequent transaction comprises the mobile communication device redeeming a coupon or code downloaded to the mobile communication device during said communicating.

14. The method of claim 12, wherein said analyzing comprises:
quantifying and comparing each of consumers present at the host location, consumers viewing the display, consumers sending said received request, and consumers participating in said communicating.

15. The method of claim 14, wherein said analyzing further comprises:
further quantifying and comparing consumers participating in subsequent transactions using the mobile communication device.

16. A server for communicating with a mobile communication device at a host location, the server comprising:
a processor;
a memory in communication with the processor;
storage in communication with the processor; and
computer-readable instructions within the server and readable by the processor that when executed cause the processor to:
deliver, to a display physically present at the host location, an invitation to the consumer to communicate via the mobile communication device;
receive a request from the consumer via the mobile communication device; and
communicate with the mobile communication device.

17. The apparatus of claim 16, wherein the computer-readable instructions comprises:
a content selection and presentation software module for selecting content including the invitation and delivering the content to the mobile communication device;
a mobile device interface software module for receiving the request and communicating with the mobile communication device; and
a data communication and processing software module for analyzing data generated from the receiving the request and the communicating with the mobile communication device.

18. A platform for communicating with a mobile communication device, the platform comprising:
the server of claim 16;
a display provided at a host location, the display being in communication with the server for delivering content, the content including an invitation to communicate with a mobile communication device; and
an interactive application stored on the mobile communication device, the interactive application being in communication with the server.

19. A method for communicating with a mobile communication device of a consumer, the mobile communication device being located at a host location, the method comprising:
causing one or more displays physically present at the host location to display video content that includes an invitation to the consumer to communicate via the mobile communication device by sending a message;
receiving the message from the mobile communication device;
generating or retrieving a coupon or code in response to said receiving;
delivering the coupon or code to the mobile communication device; and
receiving an indication when the coupon or code is redeemed using the mobile communication device.

20. The method of claim 19,
wherein the invitation comprises one or more questions;
wherein the message comprises an attempted answer to the one or more questions; and
wherein the coupon or code is delivered if it is determined that the attempted answer is correct.
